(19) United States
(12) Patent Application Publication
(10) Pub. No.: US 2007/0028229 A1
(43) Pub. Date: Feb. 1, 2007

(54) Method and system for dynamic generation of computer system installation instructions

(75) Inventor: Jim Leroy Knatcher, Round Rock, TX (US)

Correspondence Address: IBM CORPORATION;C/O DARCELL WALKER, ATTORNEY AT LAW, 9301 SOUTHWEST FREEWAY, SUITE 250, HOUSTON, TX, 77074, US

(73) Assignee: International Business Machines Corporation, Armonk, NY (US)

(21) Appl. No.: 11/191,656

(22) Filed: Jul. 28, 2005

(51) Int. Cl. G06F 9/445; G06F 9/45

(52) U.S. Cl. 717/174; 717/140

(57) ABSTRACT

An automated system generates installation instructions for software installation on a multiple machine cluster system. Pre-configured instruction modules gather information about the components on the system to be installed. From this information, an instruction installation scenario is created for each machine in the cluster system. From this scenario, the system determines which installation instructions are to be performed for each cluster machine. This system also determines the ordering of the instruction installations within a specific machine and between the machines. The invention tracks the installation process and notes the completion of each installation or installation event within the installation process. Also, a written or electronic document of the installation steps can be made available to a system user.

### FIELD OF THE INVENTION

The present invention relates to a method and system for generating documentation of instructions for computer system installations and in particular the invention relates to a method and system for automatically generating documentation of instructions for installation of clusters of hardware and software components that comprise a computing system.

### BACKGROUND OF THE INVENTION

Many activities involve installation or assembly activities. In these activities, it is often necessary to consult instructions that describe and illustrate the process of installing or assembling objects. The instructions are found installation manuals that accompany the systems for installation. In the technology arena in general and in computer technologies in particular, the installation document can be quite voluminous and complex. Installation manuals for some products are thousands of pages in length and require expert knowledge of system installations in order to correctly and efficiently install certain components in a computing system. Persons spend countless hours trying to identify and understand the installation steps for products.

Numerous methods have been proposed and implemented to automate the installation of software applications into systems in computing environments. Although numerous methods and systems have been proposed to automate many of the stages of software application development such as testing or library version maintenance, creation of the installation instructions for an executable software application, usually a final step in software application creation, has been largely underdeveloped.

Creation of software application installation documentation such as for a software interface applications can be a difficult task. Care must be taken to include documentation of all files associated with the software application and, their respective expected or required installation destination, e.g. directory or folder. Software tools for system installations may address the creation of portions of the installation process but these tools mainly focus on packaging the software itself for the installation, e.g. by supplying a “laundry list” of what goes where and when during the software installation.

Some existing methods also require an initial authoring of documentation including installation documentation followed by manual technical edits, one or more processes to include the edited documentation in a larger overall manual, distribution of the documentation, and ongoing maintenance and support. In times of updates to the software application, revision of installation documentation can be costly and involve a significant investment in labor and time.

In a typical software application installation, an installation interface is created to help users install the software application both easily and accurately. Creation of such an installation interface typically comprises creating an installation “wizard” as that term is understood by those of ordinary skill in the software programming arts, such as by using a wizard-making facility within the MICROSOFT.RTM. VISUAL STUDIO environment. Creation of the wizard typically further comprises creation of installation prompts that a software application installer must answer to set up environment specific values, by way of example and not limitation including a name of an environment being connected to, TCP/IP addresses, file locations, and the like.

A further typical component of making an installation interface is the creation and distribution of end-user installation documentation. However, creating such user documentation for installing interfaces on an integration engine is a typically manual process. For example, a developer must document the steps that an installer must follow to successfully install an interface. Moreover, a manual update of installation documentation occurs every time a change is introduced to an interface where the install procedures are changed. This process is time consuming and lends itself to having documentation and the software being out of sync. This process is also prone to error because often a plurality of people write it, usually over time, and the documentation is based on each person's interpretation of the software, whether or not it is accurate or agrees with the prior interpretations.

Attempts to address the problems associated with system installations include, U.S. Patent application 20020188939, which describes an invention that comprises a system for automated generation of installation instructions and documentation for a software interface as well as a method of using the system to automatically generate the instructions and/or documentation required to install the interface. The system comprises configuration data for a software application; a template into which data derived from the configuration data will be incorporated; a computer system comprising a memory and a processor; and software executable in the computer system for creating one or more data files that contain installation data derived from the configuration data and incorporated into the template.

U.S. Pat. No. 6,117,187 describes a method of automatically generating a software installation package. The method operates on an application program that has been ported to and debugged on a target computer system. A manifest is automatically generated, listing all application program files that must be installed on the target computer system. Then the method automatically determines which resources, in particular shared libraries, are needed by any of the listed files. Necessary filesets and sub-products are then automatically generated. Program files are then automatically assigned to the filesets and filesets are automatically assigned to the sub-products. The need for control scripts is automatically detected and control scripts are automatically generated. Then the installation package is generated by combining the listed files, filesets, sub-products, control scripts, the needed resources, and any related installation materials. The needed resources are determined by generating a dependency list, comparing it with existing software installation packages, and identifying any packages that contain needed shared libraries as needed resources.

U.S. Pat. 6,226,784, describes a reliable and repeatable process for specifying, developing, distributing, and monitoring a software system or application within a dynamic environment includes the steps of specifying a set of software system requirements during a discovery process within a data processing environment, establishing a development and delivery schedule for distribution of the software system, developing a software system corresponding to the software system requirements during a development process, and developing and testing an install package to be used to install the software system in a test environment within the data processing environment. The install package includes the software system and routines configured to automatically instantiate the software system in the test environment.

Although these disclosures show efforts to address problems in this area, these solutions address the installation of software applications into an existing computer system. There still remains a need for a means that can automatically generate installation instructions for multiple components of a computing system. With multiple computing components, the order of installation of the components can be critical. The solution must contain a dynamically generated sequence of the installation components and steps for the installation of the computing system components.

### SUMMARY OF THE INVENTION

It is an objective of the present invention to provide a method and system for generating documentation for installation of cluster components of a computing system.

It is a second objective of the present invention to provide a database of installation processes from which installation documentation for a specific computer system configuration is dynamically generated.

It is a third objective of the present invention to provide an interactive process for gathering information on a computer configuration for which installation is desired.

It is a fourth objective of the present invention to dynamically generate an instruction guide for the installation of cluster components of a computing system by compiling a document identifying locations of an installation manual that describe the instructions needed to install the components of the computer system.

It is a fifth objective of the present invention to track the installation process for installing a computer system cluster and inform the user of the current step in the installation process.

The present invention provides a method and system for dynamically generating installation instructions for installing software on cluster components in a computing system. In this system is a database component that contains questions, installation instruction sets and installation scenarios of typical and known machine and cluster installations. This method compiles a series of inquiries for the purpose of gathering information about the features or characteristics of the computing systems. These inquiries are arranged in a structure that allows the prompting of a question based on a response to a previous question. These inquiries involve both static questions of basic information related to any computing system and dynamic questions, which would be asked, based on information gathered during the inquiry process. A static question could be whether the desired computer system will be a functional cluster, regular or sub-cluster. A cluster is a collection of machines in a system.

After completion of the database construction, the next step is to detect when there is a system installation inquiry. This installation inquiry initiates the actual system installation process. The third step is to actually gather the information that will be used to generate the specific installation documentation. This step accesses the questions stored in the database and records the response to these questions. The next step is to generate the specific installation instructions and instruction documentation. From the responses to these questions, the present invention can compile a set of instructions from an instruction database or from an electronic version of an installation manual. The final step produces a document containing the set of installation instructions. With regard to the instructions generated from the electronic manual, the documented instructions can comprise a list of locations in the installation manual of the descriptions for installing a particular computer system software component.

An optional feature of the present invention is the capability to track the steps during the actual installation of software on the cluster system. In this step, there would be listing of the instructions to be completed during an installation. At the completion of each instruction, this completion would be recorded. The installer could be notified of the completion of that step and shown where they are in the installation process. If the installer chose not to complete the entire installation at one time, the stopping would be noted. When the installer wanted to continue the installation, the process would continue at the previous stopping point.

### DESCRIPTION OF THE DRAWINGS

FIG. 1 is an illustration of a multiple machine cluster to which the methods and instructions of the present invention can apply.

FIG. 2 is an illustration of a computer network configuration through which one can implement the method of the present invention.

FIG. 3 is a flow diagram that illustrates the basic steps in the method of the present invention.

FIG. 4 is an illustration of a database containing various instructions and instruction sets that are used in the implementation of the present invention.

FIG. 5 shows a configuration for generating installation questions and installation scenarios in accordance with the present invention.

FIG. 6 shows a configuration for generating installation questions and installation scenarios in accordance with the present invention.

FIG. 7 shows an example of various installation scenarios for the installation of machines of cluster in accordance with the present invention.

FIG. 7a gives examples of different installation instruction scenarios for machine in a cluster system.

FIG. 8 is a flow diagram of steps in the implementation of the present invention.

### DETAILED DESCRIPTION OF THE INVENTION

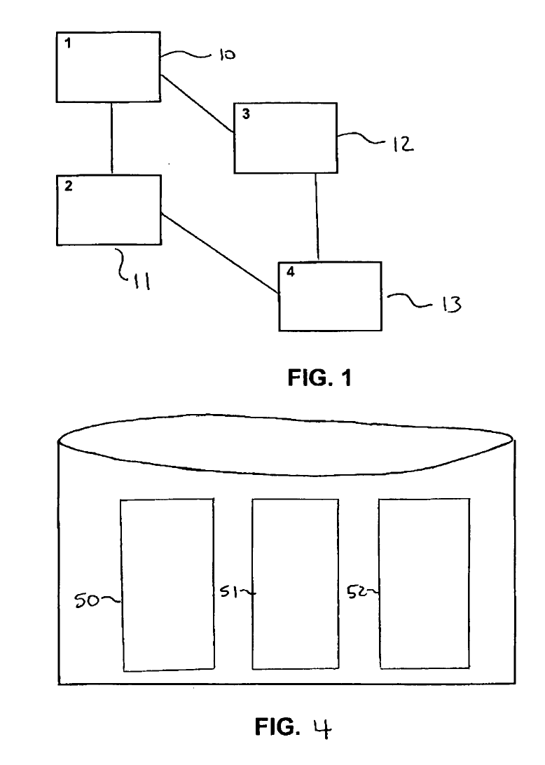

The present invention provides a method to generated documented instructions for the installation of a multiple machine-computing network. There are least two connected machines in this network configuration. The devices that comprise the computing network can extend over multiple cites and can include both central and remote locations. FIG. 1 is an illustration of a multiple machine cluster to which the methods and instructions of the present invention can apply. As shown, the cluster has four machines 10, 11, 12 and 13. In the installation process, machine 10 may be directly connected to machine 11. Machine 11 may then be connected to machine 12. With the multiple machines, it may not be well understood that the sequence of installing these machines can be critical to the successful installation of the system. The connection sequence is very important for proper installation of the system.

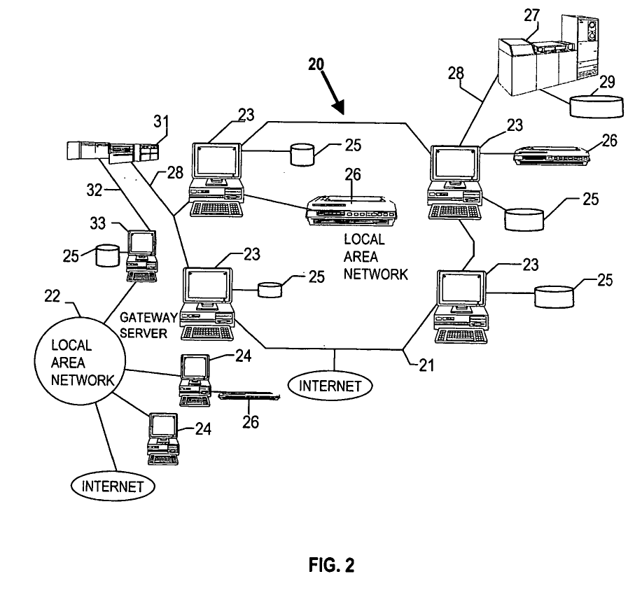

FIG. 2 is depicted a pictorial representation of a distributed computer network environment 20 in which one may implement the method and system of the present invention. The installation can be from the standpoint of interacting via a webpage to generate a set of installation instructions. FIG. 2 also illustrates a system in which one can install a cluster configuration. As may be seen, distributed data processing system 20 may include a plurality of networks, such as Local Area Networks (LAN) 21 and 22, each of which preferably includes a plurality of individual computers 23 and 24, respectively. Of course, those skilled in the art will appreciate that a plurality of Intelligent Work Stations (IWS) coupled to a host processor may be utilized for each such network. Any of the processing systems may also be connected to the Internet as shown. As is common in such data processing systems, each individual computer may be coupled to a storage device 25 and/or a printer/output device 26. One or more such storage devices 25 may be utilized, in accordance with the method of the present invention, to store the various data objects or documents which may be periodically accessed and processed by a user within distributed data processing system 20, in accordance with the method and system of the present invention. In a manner well known in the prior art, each such data processing procedure or document may be stored within a storage device 25 which is associated with a Resource Manager or Library Service, which is responsible for maintaining and updating all resource objects associated therewith.

Still referring to FIG. 2, it may be seen that distributed data processing system 20 may also include multiple mainframe computers, such as mainframe computer 27, which may be preferably coupled to Local Area Network (LAN) 21 by means of communications link 28. Mainframe computer 27 may also be coupled to a storage device 29 which may serve as remote storage for Local Area Network (LAN) 21. A second Local Area Network (LAN) 22 may be coupled to Local Area Network (LAN) 21 via communications controller 31 and communications link 32 to a gateway server 33. Gateway server 33 is preferably an individual computer or Intelligent Work Station (IWS), which serves to link Local Area Network (LAN) 22 to Local Area Network (LAN) 21. As discussed above with respect to Local Area Network (LAN) 22 and Local Area Network (LAN) 21, a plurality of data processing procedures or documents may be stored within storage device 29 and controlled by mainframe computer 27, as Resource Manager or Library Service for the data processing procedures and documents thus stored. Of course, those skilled in the art will appreciate that mainframe computer 27 may be located a great geographical distance from Local Area Network (LAN) 21 and similarly Local Area Network (LAN) 21 may be located a substantial distance from Local Area Network (LAN) 24. That is, Local Area Network (LAN) 24 may be located in California while Local Area Network (LAN) 21 may be located within Texas and mainframe computer 27 may be located in New York.

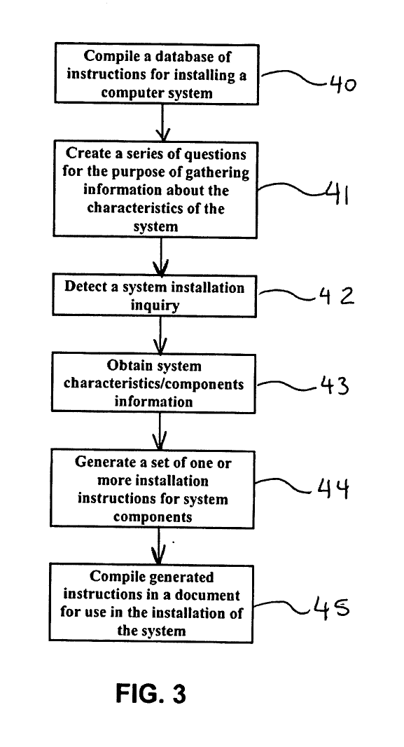

FIG. 3 is a flow diagram that illustrates the basic steps in the method of the present invention. As shown, step 40 is an initial step where the compiling of an instructional database occurs. In this step, system creators/designers assemble sets of instructions for installing known network (cluster) configurations. These instruction sets represent both installation scenarios for individual devices within clusters as well as the entire cluster system. A scenario is a set of steps in an installation of a known machine. For example, there could be a set of installation instructions for each machine in FIG. 1. Further, there could be instructions for installations of a machine (i.e. a network interface) in various system configurations. FIG. 4 shows database containing various the instruction sets 50, question sets 51 and ordering rules 52 for the installation of a cluster in the present invention. The instruction set module contains both installation instruction sets and installation scenarios. The number of scenarios and instruction sets can extend into the thousands. Each instruction or instruction can have an identifier and is indexed to facilitate prompt location of the set. For example, if machine 10 from FIG. 1 was an interface device, instruction sets related to this machine and/or installation of interface devices would be tagged and possibly linked. In addition, the instruction sets could be identified based on the specific machine. The instruction set information can also indicate the actual machine model in addition to the machine's function as an interface device.

In addition to the instructions sets, the database can have a section that contains an electronic version of the corresponding installation manual for a particular system. As mentioned, one of the problems with the conventional approach to system installations is that the user has to search through one or more voluminous documents for all of the relevant locations for installation of the components of the system. This electronic document can have installation sections identified in an index that correspond to the instructions for installing components in the system configuration. For example, the instructions for installing a machine interface component may be found in a certain, section of the installation guide. The present invention could have a specific instruction set for installing that interface. The present invention can also generate the actual manual section that contains that information. This approach provides at least two forms of benefits. First, the user will have a set of installation instructions for that interface. Second, the user will have a reference in the installation guide for the source of the installation instructions. Both of these resources can useful for future interface installations.

Again, referring to FIG. 3, step 41 generates a series of inquires/questions for the purpose of gathering information about the features and characteristics of the system that is the subject of the installation. These inquiries will be in two parts: a static set of questions and a dynamic set of questions. In step 41, the static questions comprise questions that are asked with each installation process. These questions are designed to gather information about certain features that are basic to any system installation. With information gained from the responses to the static questions, the invention can generate a set of dynamic questions.

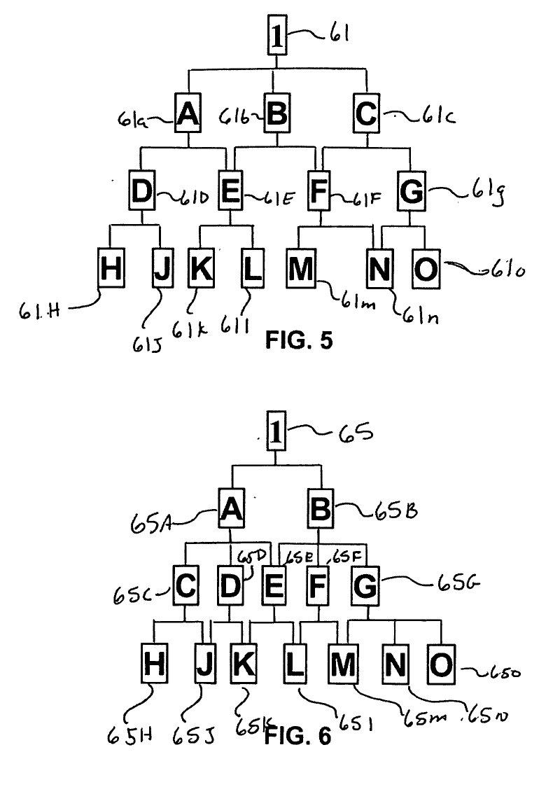

FIG. 5 shows an example of a dynamic question configuration. For a machine (machine 1), each box represents potential question and optional answer information. For an initial static question, there can be a three-option answer. These answers would be 61a, 61b and 61c. The answer selected by a user to this initial question would provide system configuration information and would determine the next question. System designer know that for certain types of machines, there are certain configuration options that will define the function of the machine in the cluster. One option, 61a, could be a user interface function. The 61b option could a network interface function. If option 61a were chosen, the next question, also with options, could be question 61e. These additional questions would also be configured to flow from the previous questions and answers. If the machine was a network interface (61b), the flow-up questions would related to network interface installations. This process would continue through the question configuration for that machine. This series of questions and answers will result in a question configuration that can be useful for future installations. The responses would reveal more information about the machines in the cluster configuration in general and a particular machine 1 in the context of this cluster. The designers can configure the question scenarios based on their experience with the various types of cluster configurations, the types of machines incorporated into these configurations and the types of tasks the machines perform.

Referring again to FIG. 3, step 42 detects an installation inquiry. This detection indicates that a user is interested in installing a cluster system. Step 43 begins the process of obtaining specific information about the installation. This step 43 will incorporate the question generating techniques and resources related to the question configuration in FIG. 6. The inquiry would begin with a series of static or standard questions. Depending on the answers to these questions, there would be an identification of a dynamic question scenario such as a 61a, 61e, 61k question sequence of FIG. 5. The answers to these questions would generate a set of system characteristics for use in determining the type of instructions necessary for the system installation.

Step 44 of FIG. 3 would generate a set of installation instructions for the system components based on the system characteristics information gathered in step 43. In an example, the answer for each question in step 43 could indicate the installation of a certain instruction set. If the answer to one question was that machine 1 would have a WebSphere ® application server, then the instructions for installation of a WebSphere application server could be retrieved from the database as part of the overall set of installation instructions. At the completion of step 44, all of the retrieved installation instruction sets would be compiled in step 45 in order to generate a documented set of instructions for the particular system installation.

In FIG. 6, there can be a series of installation instructions that result from the information gathered from the user. In practice, the dynamic questioning of step 43 and the generating of a set of instructions in step 44 can occur in combination. As previously mentioned, FIG. 6 shows configurations for determining an installation configuration. FIG. 6 shows an example of an installation configuration with sets of instructions. The cluster machine is machine 65. The first question related to machine 65 might result in the selection of option 65b. This selection would indicate the need perform a certain set of installation instructions corresponding to option 65b. The selection could also generate an additional or follow-up question. The answer to this follow-up question 65g would indicate the need to perform another set of installation instructions. In both cases, the designers will compile various configurations that can occur with the technology that a user wants to install. The type of technology may limit these configurations. In other cases, there can be numerous installation configurations. For example, in FIG. 6, there could be an instruction scenario based on 65a, 65c, 65h Initially, the number of installation configurations is limited by the knowledge of the designers or by the practically of selecting certain typical or standard configurations for which a technology was designed to work.

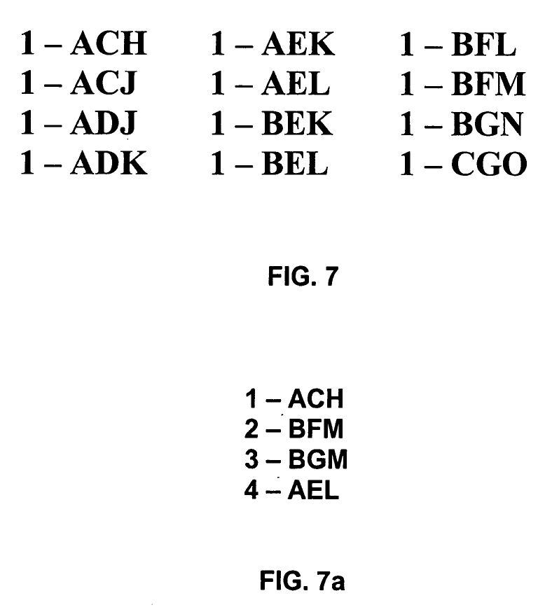

FIG. 7 shows various installation scenarios based on the configuration of FIG. 6. Although the actual configuration contains many more combinations, this example is to illustrate the concepts and steps of the present invention. Each machine of a cluster will have a similar installation instruction generation configuration. For example, in a four-machine cluster, the question and instruction configurations of FIG. 5 and 6 could be used to determine the installation instructions for each machine. In a cluster installation containing these four machines, there are in excess of 64 different instruction combinations. An actual installation instruction model could easily have several thousand instruction installation combinations.

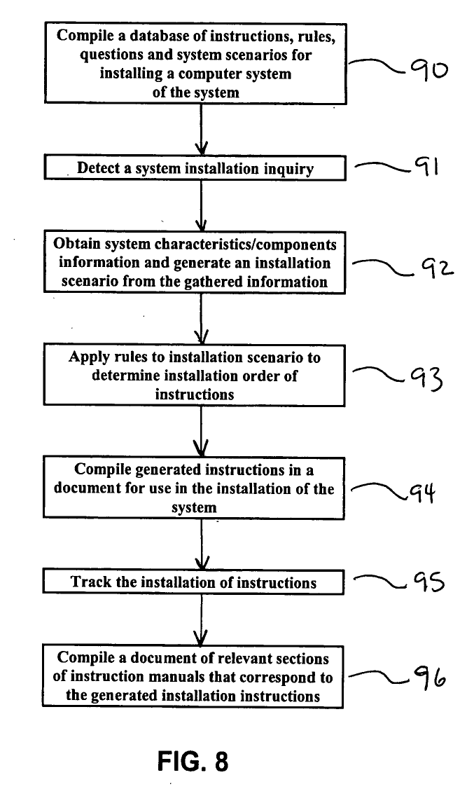

FIG. 8 illustrates the steps in a specific implementation of the present invention. As with FIG. 3, step 90 compiles a database of possible installation instruction scenarios. This structure will similar to FIG. 7. As mentioned, the particular format of the instruction scenarios can vary. In this example, the format is the tree structure of illustrated in FIG. 7. Step 90 also compiles a database of possible question scenarios. This process for compiling the question scenarios is similar to the compilation of installation instructions in this step 90. The database can have a component that determines the order of installation steps. This instruction installation ordering will affect both instruction sets and individual installation instructions. With cluster systems comprising multiple machines, in addition to installing the proper components for the cluster, it is important to install the components in a proper order. Failure to adhere to the proper installation order or sequence can result in many installation problems.

At this point, the method goes to a monitoring state. In step 91, the method detects a system installation inquiry. This inquiry could come via an HTML webpage entry. Step 92 begins the process of gathering information in order to generate a scenario of the potential installation. This step uses the question scenario format of FIG. 5 to generate this list of questions. In this step, the method starts by using a set of static questions to gather information from the user. From this information, the method generates a particular dynamic question scenario from which to gather additional information from the user. The scenario of FIG. 5 could be the scenario used to dynamically gather information. As the process moves through the set of questions, it also generates an installation instruction scenario. The instruction scenario is internally generated from the results of the questions. In an example of the user asking questions for machine 1, if the user selects option 61b, this answer would generate a set of installation instructions to perform that portion of the installation. If option 61b was a websphere feature, then the instruction set for installation of the WebSphere would be tagged and incorporated into the into the installation instructions for machine 2.

At the completion of step 92, there is an instruction installation scenario for the installation the system. This installation scenario may be viewed as the path created as the user navigates through the question configuration of FIG. 5 or the instruction installation configuration of FIG. 6. Referring to FIG. 7a and based on the installation instruction configuration of FIG. 6, the installation scenario for a four-cluster machine may be: Machine 1—ACH; Machine 2—BFM; Machine 3—BGM and Machine 4—AE. These letter combinations represent the installation instruction sets for each machine as determined by a configuration module such as shown in FIG. 6. Step 93 uses predetermined rules to establish an order for installation of the sets of instructions. For example, there may be a rule, which requires the simultaneous or sequential installation of machines that share an installation instruction set. In this case, machines 2 and 3 share instruction set m (65m). According to the rule, there is a defined order installation for machines 2 and 3. Another ordering may be that a machine having the fewest installation instructions is installed first. In this example, the machine would be machine 4 having only two instruction sets. For this particular instruction scenario, there may not be any additional installation rules. In another situation, there may be rules that define the installation for each machine and each instruction or instruction set within the machines.

In an alternate embodiment, the instruction scenarios in the database can be generated in an order that has already incorporated any required ordering. With this approach, the generated installation scenario of step 92 would be compared to (or matched with) the predetermined scenarios in the database. A corresponding instruction scenario would be identified from the database.

With either approach, step 94 would compile the instructions for the installation scenario that matches the desired system installation. The generated instruction set can be compiled into a written set of instructions for the user or electronically stored. When the user is ready to install the system, step 95 can monitor the installation using the electronically stored instructions. As the installation takes place, the monitor notes the completion of each step. If the installer, decides not complete the installation in one setting, the monitor will note the stopping point of the installation. When the installer is ready to resume the installation, the monitor informs the installer of previous stopping point. The installer can resume the installation at that point. Step 96 can generate a written or electronic compilation of the installation steps to better assist the installer/user in the future.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

We claim:

1. A method for dynamic generation of computer system installation instructions in a machine cluster environment comprising the steps of:
compiling a set of installation instruction scenarios for various known machine installations, the set of installation instruction scenarios being stored in an installation instruction database;
gathering information about a machine cluster system on which computer software is to be installed;
generating a set of installation instructions for the installation of the machine cluster system based on the gathered information;
determining the order of the installation of the machines in the machine cluster system to be installed; and
tracking the installation of the instructions during the actual machine cluster installation process and informing an installer of the completed installations.

2. The method as described in claim 1 further comprising before said gathering step, the step of compiling a set of installation questions and a set of rules that determine the order of installation of a set of installation instructions, the installation questions and set of rules also being stored in the installation instruction database.

3. The method as described in claim 2 wherein said installation questions comprise a tree structure wherein a question has one or more predetermined responses, a response to a question providing information about features of one or more machines in a cluster computing system.

4. The method as described in claim 3 wherein said instruction generating step further comprises the steps of:
generating an installation instruction scenario from responses to questions in said information gathering step;
comparing the generated installation instruction scenario to instruction scenarios stored in the installation instruction database; and
selecting a scenario from the installation database that matches the generated installation instruction scenario.

5. The method as described in claim 4 wherein said scenario generating step further comprises recording each question and each response during said installation gathering step such that the responses to questions create a path through the set of questions, this path corresponding to an instruction scenario.

6. The method as described in claim 2 wherein said installation order determining step further comprises:
identifying a presently generated instruction installation scenario for the software installation on the machine cluster system;
matching that the identified installation scenario to an installation scenario stored in an installation instruction database; and
applying an installation order of the stored installation scenario to the presently generated instruction installation scenario.

7. The method as described in claim 2 wherein said installation order determining step further comprises:
identifying a presently generated instruction installation scenario for the software installation on the machine cluster system; and
applying ordering rules to determine the order of the installation instructions.

8. The method as described in claim 1 further comprising after said tracking step, the step of generating a document of the generated instructions used in the installation of the cluster system.

9. The method as described in claim 8 wherein the instruction installation document contains sections and specific locations, in an installation manual, that correspond to the installation instructions used in the installation of the presently generated cluster system.

10. The method as described in claim 2 wherein the questions arranged in a tree structure representation having questions which can have two or more option answers for the question, said questions and optional answers comprising multiple levels of questions; and a terminal level of questions having no optional answers.

11. A system for dynamic generation of computer system installation instructions in a machine cluster environment comprising:
an installation instruction database having an installation instruction module, an installation questions module and a rules module for ordering an installation sequence;
a monitor program that tracks the installation of complex software on a cluster system; and
a program to generate a document containing the instructions for the software installation on a cluster system.

12. The system as described in claim 11 further comprising a document containing installation instructions for a cluster computer system installation as defined by responses to installation questions and as arranged in accordance with ordering rules.

13. The system as described in claim 12 further comprising an information gathering program for obtaining information about the cluster computer system for which installation is desired.

14. The system as described in claim 13 further comprising an interface that enables said information gathering program to interact with an installer for the purpose of gathering cluster computer system information.

15. The system as described in claim 14 wherein said interface can be a web page located in a machine on a computing network, said web page being in communication with an installer via the computing network and said web page also being in communication with said information gathering program.

16. The system as described in claim 13 wherein said information gathering program further comprises questions arranged in a tree structure in which a question has one or more predetermined responses, a response to a question providing information about features of one or more machines in a cluster computing system.

17. A computer program product in a computer readable medium for dynamic generation of computer system installation instructions in a machine cluster environment comprising:
instructions for compiling a set of installation instruction scenarios for various known machine installations, the set of installation instruction scenarios being stored in an installation instruction database;
instructions for gathering information about a machine cluster system on which computer software is to be installed;
instructions for generating a set of installation instructions for the installation of the machine cluster system based on the gathered information;
instructions for determining the order of the installation of the machines in the machine cluster system to be installed; and
instructions for tracking the installation of the instructions during the actual machine cluster installation process and informing an installer of the completed installations.

18. The computer program product as described in claim 17 further comprising before said gathering instructions, instructions for compiling a set of installation questions and a set of rules that determine the order of installation of a set of installation instructions, the installation questions and set of rules also being stored in the installation instruction database.

19. The computer program product as described in claim 18 wherein said installation order determining instructions further comprise:
instructions for identifying a presently generated instruction installation scenario for the software installation of the machine cluster system;
instructions for matching that the identified installation scenario to an installation scenario stored in an installation instruction database; and
instructions for applying an installation order of the stored installation scenario to the presently generated instruction installation scenario.

20. The computer program product as described in claim 17 further comprising after said tracking instructions, instructions for generating a document of the generated instructions used in the software installation of the cluster system.
